(19) United States
(12) Patent Application Publication
(10) Pub. No.: US 2005/0123001 A1
(43) Pub. Date: Jun. 9, 2005

(54) Method and system for providing video and data traffic packets from the same device

(76) Inventors: Jeff Craven, Cumming, GA (US); Mark Bugajski, Norcross, GA (US); Charles Cheevers, Cork (IE); Ian Wheelock, Cork (IE); Denis Downey, Cork (IE); Michael Harrington, Cork (IE)

Correspondence Address: ARRIS INTERNATIONAL, INC, 3871 LAKEFIELD DRIVE, SUWANEE, GA, 30024, US

(21) Appl. No.: 10/982,211

(22) Filed: Nov. 5, 2004

Related U.S. Application Data
(60) Provisional application No. 60/517,342, filed on Nov. 5, 2003.

(51) Int. Cl. H04H 1/04

(52) U.S. Cl. 370/486

(57) ABSTRACT

A device receives packets associated with a program stream at an addressable communications port, and assigns them to one of a plurality of QAM channels. Multiplexed program packets, DOCSIS data or multimedia packets or a combination of both, are transmitted over the QAM channel. DSG messaging transports requests for content to a server, transports queries to mapping tables and returns information from the tables to a manager that, along with processors, determine which channel to use for downstream transport of the multiplexed streams. The manager assigns a connection identifier corresponding to a channel and program number combination to the packets, and sends the identifier, via DSG, to the requesting/receiving user device; the identifier instructs the user device how to tune and receive the requested packets. The identifier may use seven bits for program numbers, two for output port number and two for channel frequency.

### CROSS REFERENCE TO RELATED APPLICATION

This application priority under 35 U.S.C. 119(e) to Bugajski, U.S. provisional patent application No. 60/517,342 entitled “Video Edge-QAM/CMTS,” which was filed Nov. 5, 2003, and is incorporated herein by reference in its entirety.

### FIELD OF THE INVENTION

The present invention relates generally to video and broadband communication networks, and more particularly to a method and system for providing video content traffic and IP data traffic from the same device.

### BACKGROUND

Community antenna television (“CATV”) networks have been used for more then four decades to deliver television programming to a large number of subscribers. The CATV networks have typically been implemented using coaxial cables that form a network for electrically providing a signal path for video signals.

In addition to providing analog, and more recently digital, video broadcast television signals, cable service providers are increasingly adding broadband data services to their offerings to customers. These data services typically include Internet access using the Data Over Cable Service Interface Specification (“DOCSIS”) protocol. To provide television and data services, a service provider typically uses a cable modem termination system (“CMTS”) for the data services and a quadrature amplitude modulation (“QAM”) multiplexer for downstream broadcast television, narrowcast and video on demand (“VoD”) traffic signals.

These CMTS and QAM multiplexer devices are typically separate components in a rack, or, frame, chassis, which includes various rack-mount components at a service provider's head end location. These devices may also be located at one or more hubs, which are typically connected to the head end via a network according to a networking protocol, such as, for example, Ethernet or SONET, as known in the art. Each device may have multiple outputs for downstream signals, as well as multiple inputs for upstream signals. The CMTS component may also have multiple input RF connection ports to support multiple physical upstream channels (current CMTSs typically use multiple upstream physical channels to each physical downstream channel so that noise from each subscriber's home is not aggregated into a single channel). The QAM multiplexer typically has broadcast RF F-connector connections for downstream audio and video signals (these may be collectively referred to as multimedia signals, which may include signals of other types as well, such as, for example, closed captioning), and other directed RF F-connector connections for directing downstream Video on Demand (“VoD”) signals to a particular subscriber or subscribers.

Thus, typically at least three types of downstream signal connections connect cabling to at least three corresponding cable network architectures. For example, for downstream data traffic, four nodes may be used to support 2000 homes. Thus, a single RF output from one CMTS component would be connected to a splitter/router to support the 2000 homes. Such a splitter/router would distribute signals from the CMTS according to traffic engineering analysis in an attempt to maximize the amount of available bandwidth used in a given downstream channel. For broadcast video signals, a single signal is sent to all subscribers, with splitters and amplifiers along the way to maintain signal strength as the single signal is delivered to all subscribers.

However, supplying VoD signals, although video/multimedia signals, is more akin to providing downstream data signals rather than broadcast video, because one subscriber may wish to start viewing a movie at 8:00 and another user may wish to start viewing the same movie at 8:05. Thus, a separate signal is typically fed to each subscriber. Moreover, since each signal typically is provided to a different subscriber at a different location than another subscriber, each VoD program is typically routed according to an identifier, such as an IP address, MAC address, or port identifier corresponding to the requesting subscriber as known in the art. In addition, each program may comprise multiple streams, one for video, one or more for audio, including surround sound, and another for closed captioning, for example. Each stream, although being associated with a single multimedia program, is typically assigned a stream identifier, or program identifier (“PID”), that is different from, and unique to, each stream transmitted in the same QAM channel.

To facilitate these directed streams to specific subscribers, as well as deliver broadcast video and data packet streams, providers operate different types of cabling networks corresponding to the types of signals being transmitted. For example, for broadcast video, one connection from a QAM multiplexer can supply the same signal to a plurality of nodes, as each node can tune to a different frequency of the multiplexer. The signals are then forwarded from the nodes to subscriber's equipment, where signals are decoded and viewed as multimedia content.

To accommodate data traffic, a PID data stream identifier that is unique to data streams, and used for all data streams, identifies all data packets, regardless of the particular intended destination device. Each user data device, such as, for example, a cable modem, disregards all non-data packets (those that do not contain the unique data stream identifier) and uses the embedded destination IP address to determine whether to load or disregard a particular packet.

VoD multimedia signals are routed according to the subscribers being served. However, when separate CMTS and QAM multiplexer components are used at a provider's head end, separate cable networks are generally used for providing data traffic and VoD traffic to subscribers. Thus, there is a need for a device that supports multiple types of downstream signal streams from the same downstream connection, thereby reducing the need for separate cabling networks for different types of content signals.

Another consequence of separate components is that not only are multiple routed-signal cable networks used, thereby increasing the costs for equipment and material purchase and maintenance, but available bandwidth may not always be completely maximized, even when usage perfectly matches traffic engineering analysis. One reason for this is that a given physical QAM channel has a maximum available bandwidth as governed by the laws of physics. However, the bandwidth used by a given signal, whether multimedia or data, is rarely an amount such that when added to the corresponding bandwidth of other signals transmitted in the same QAM channel equals the maximum available bandwidth of that channel. Thus, to avoid loosing packets if the sum of all the signals in a channel exceeds the physical maximum, signals are often routed so that all of the available bandwidth is not used, thus providing a cushion when data rates spike in a given channel. Unused, or un-maximized, bandwidth is undesirable to a provider, as capacity that has been paid for is not being used to deliver content to subscribers. An example of how this can occur is illustrated by the following example.

If, for example, a channel has a maximum available bandwidth of 30 Mbps, and three subscribers are requesting content needing 20 Mbps, 7 Mbps and 5 Mbps, either the 7 Mbps or the 5 Mbps signal would have to be transmitted over a different channel, thus leaving 5 or 7 Mbps unused respectively. At the same time, a separate CMTS component may be transmitting signals to twenty Internet users needing nominally 2 Mbps each. Since the sum of the Internet bandwidth needed is 40 Mbps, each Internet user may experience reduced performance, as packets are buffered or resent, as known in the art. However, if some of the Internet traffic could be routed through the channel having unused capacity, all of the Internet users would experience better performance and the multimedia subscribers would not experience decreased in performance. Thus, there is a need for a device that can make port, channel and program assignments.

In addition, separate components takes up physical space in a head end or hub location. Thus, there is a need for a device that reduces the amount of space used for separate CMTS and QAM multiplexers.

### SUMMARY

A combined transmission device combines features and functionality of a CMTS component and an edge QAM multiplexer component such that downstream digital multimedia content packets and downstream digital data signal packets can be transmitted downstream from the same output port in the same QAM channel (ports can typically output more than one QAM channel, as known in the art). When a packet is received from an addressable network, such as an Ethernet network, for example, a software client process determines what type of packet it is (i.e., television content, internet-sourced content such as programs from MOVIELINK®, VoD, or DOCSIS data). The client process determines the packet type based on an identifier that may be contained in the packet header. A destination device address contained in the packet, for example, an IP address, may indicate that the final destination of the packet is to be a specific client device such as a cable modem, PC, or any IP-aware device. If so, the packet is forwarded to a DOCSIS processing section and then sent to an output section for downstream transmission at a predetermined frequency.

Similarly, if the destination address is an IP-unaware television STB, for example, DOCSIS processing is not required, but a delivery mechanism is nevertheless facilitated. The packet is forwarded to an output section—either the same or different from the one to which DOCSIS packets may be sent. Depending on the number of data and multimedia flows the combined transmission device is configured to handle, there may be multiple downstream output sections, where each may be capable of transmitting multiple QAM channels, each with corresponding unique transmit frequencies, to accommodate the amount of bandwidth needed to support the desired number of data and multimedia flows.

To determine the frequency and downstream output section/port from which a packet is to be transmitted, a next-available combination of output port, channel and program number is assigned from a stream mapping table to a program (a collection of streams) based on a port assignment. A port assignment refers to a physical connection of a particular user device to a single output port, and port assignment information is stored in a device mapping table. Thus, a processor can evaluate a packet's header and determines the packet's destination address and switching/routing architecture causes the packets associated with the evaluated stream to be forwarded to the matching output section according to results returned form querying the tables. If the packet is a data packet such as a DOCSIS packet for example, it is processed through a DOCSIS processor before being transmitted from the output section. A stream identifier uniquely associated with DOCSIS traffic is added to data packets, as known in the art.

This stream identifier is used in a transport scheme, such as MPEG2-Transport, to identify the packet as belonging to a particular program and associate it with other packets of the same stream. If the device to which a packet is destined is a cable modem, for example, the cable modem detects the stream identifier as a data packet, strips away the stream identifier, and then evaluates a destination device address, such, as, for example, an IP address, and determines whether the packet matches its IP address. If so, the data packet is processed by the modem.

If the device receiving the stream is to be an STB, the STB will accept packets associated with a program it is programmed to receive, and will reject other program streams, including data streams. Regardless of packet payload, the modem and/or the STB are tuned according to the stream mapping table to a QAM channel frequency corresponding to the intended stream. This device connectivity mapping database is typically sent downstream periodically from the combined transmission device to user devices, as known in the art. Accordingly, DOCSIS data packets and multimedia content packets can be transported simultaneously from the same combined transmission device in the same QAM channel.

### BRIEF DESCRIPTION OF THE DRAWINGS

FIG. 1 illustrates a system for providing multimedia and data signals to subscribers from the same device.

FIG. 2 illustrates a system using a combined transmission device for routing packet streams to a plurality of output ports within a combined transmission device.

FIG. 3 illustrates a bit arrangement for designating a port, channel and program using a UDP port designation.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

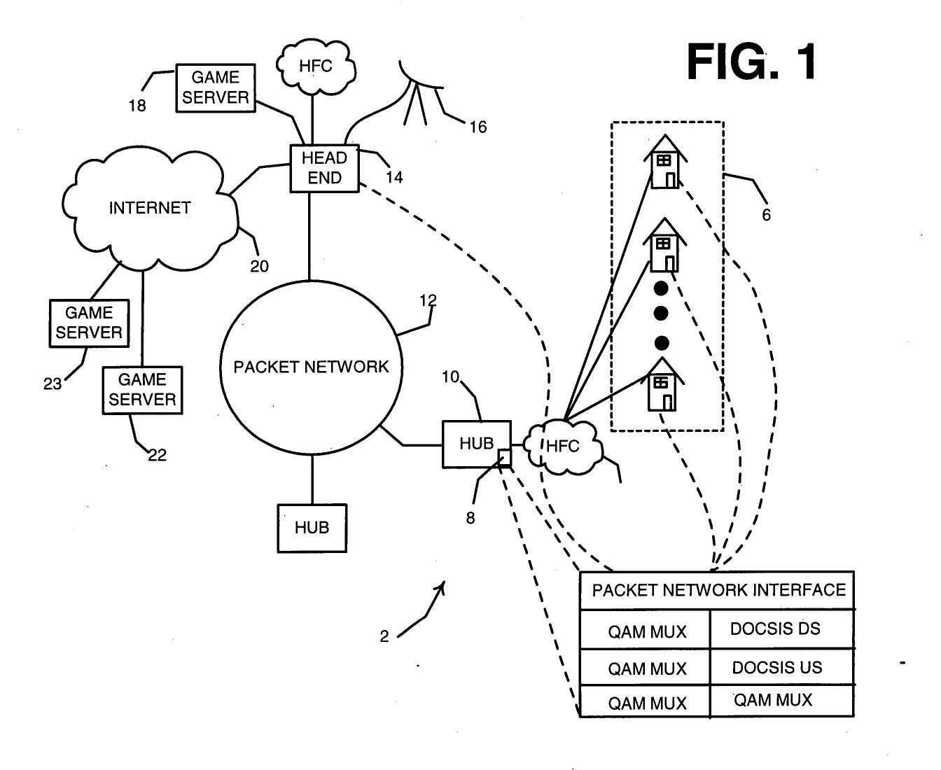

Turning now to the figures, FIG. 1 illustrates a system 2 for providing downstream multimedia signals and data signals over a communication channel. Preferably, the communication channel is a QAM channel over a hybrid fiber coaxial (“HFC”) network 4 that supplies signals to user devices, such as cable modems and STB, for example. The user devices are represented in the figure by house icons 6—a typical residence may have multiple devices. A combined transmission device 8 at hub 10 receives downstream packet signals from addressable packet network 12, which is preferably an Ethernet network, but may be other types of networks, including SONET and other similar networks known in the art. Hub 10 receives downstream packet traffic from head end 14 via network 12, and head end 14 typically receives content from multiple sources, such as television programming via a satellite receiver, a game server 18 and the internet 20. Thus, any type of packet may be received from the internet 20, including data from a game server 22 or multimedia content from a IP movie server 23, such as, for example, MOVIELINK®, a registered trademark of Movielink, L.L.C., in addition to internet data traffic and broadcast multimedia content.

Such IP traffic received at head end 14 from Internet 20 may be transported as IP traffic from the head end to hub 10 for ultimate transport from the hub to users 6 as DOCSIS traffic or as a multimedia traffic stream. Thus, depending upon the user device 6 that is requesting the traffic, combined transmission device 8 may transmit packets as DOCSIS traffic packets or multimedia content. The transport protocol for transmitting packets from combined transmission device 8 towards users 6 is preferably MPEG2 Transport. Since the DOCSIS standard specifies MPEG2 transport, DOCSIS traffic packets and multimedia packets can be sent from combined transmission device 8 from the same downstream port and even in the same QAM channel.

To facilitate this multi-source-packet traffic, combined transmission device 8 determines if incoming downstream traffic is DOCSIS data packets or multimedia packets. As known in the art, multimedia packets typically arrive from network 12 with a source address and destination address in an IP header. Associated with the addresses are typically source and destination User Datagram Protocol (“UDP”) port numbers respectfully, as known in the art. Multimedia packets are formatted into preferably MPEG2 Transport packets as known in the art, and the UDP port numbers are used to distinguish between downstream programs being sent to a plurality of users. Streams within a given program are assigned unique PIDS from a pool of PIDS associated with a given QAM channel.

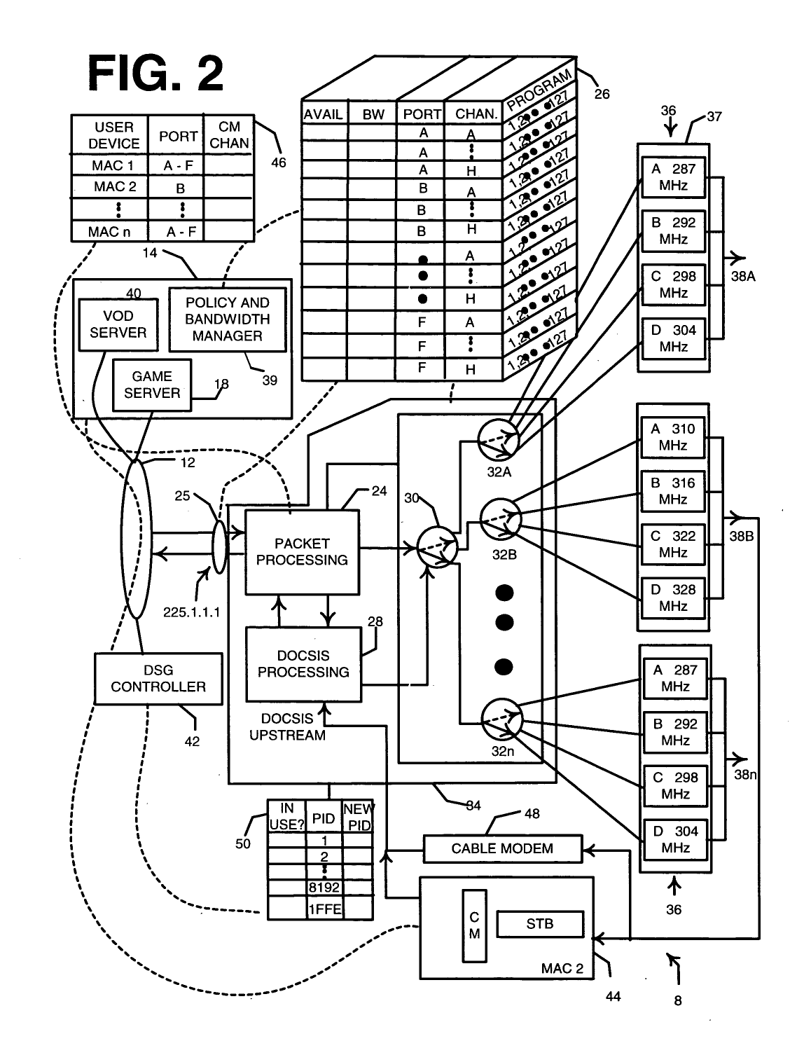

A DOCSIS processor, which will be discussed further in reference to FIG. 2, formats a DOCSIS IP packet into an MPEG2 Transport format, and inserts a PID that uniquely identifies DOCSIS data packets. The DOCSIS protocol currently specifies that the PID for DOCSIS packets in the United States is 1FFE, a thirteen-bit hexadecimal number. After adding the DOCSIS PID to data packets, combined transmission device 8 merges, or multiplexes, DOCSIS data packets with multimedia data packets for transport over HFC 4 to users 6.

Combined transmission device 8 also coordinates downstream DOCSIS data packet transmission with upstream DOCSIS data packets received from users 6 over HFC 4. Thus, downstream DOCSIS data packets and downstream multimedia traffic packets can be transported over the same downstream QAM channel frequency from a single output port. Accordingly, the advantages of a simpler downstream HFC network made up of fewer different traffic networks, as discussed above in the Background section, and reduced equipment footprint required at head end 14 are realized.

Turning now to FIG. 2, a block diagram of components that compose combined transmission device 8 is illustrated. Downstream traffic is received from network 12 by packet processor 24 at addressable port 25. Port 25 is preferably an IP port having a fixed IP address as known in the art. However, other addressing schemes may be used. When IP addressing is used, port 25 uses an address prefix that is recognized as referring to a particular-use port, such as, for example, for transmitting and receiving multimedia content. In the example, 225.x.x.x is used to refer to such an addressable, multimedia interface.

Processor 24 preferably comprises multiple microprocessors and memory sections, as known in the art, for storing and manipulating packets. For example, a stream-mapping table 26 may be loaded into a memory coupled with processor 24. The stream-mapping table 26 preferably associates a program number, a port number and a channel number with an available flag field indicating whether a particular combination of program number, port number and channel number is currently available. If the available flag field indicates that a given combination is not available, a program bandwidth field contains a value representing the bandwidth currently used by, or allocated to, the program corresponding to the combination. This program bandwidth field is later used to determine the combined amount of bandwidth currently allocated to a QAM channel. Should the allocation reach a threshold such that an additional program can not be added without oversubscription, the stream mapping table 26, in conjunction with the packet processing processor 24 will map the new required program to a QAM channel that is less burdened and would not be oversubscribed.

It will be appreciated that for clarity, only port and channel number are illustrated in table 26. However, in the preferred embodiment, there may be multiple modules in a device that interface with port 25, and another filed in table 26 may be used to indicate one of the plurality of modules. Therefore, only one processor 24, and DOCSIS processor 28 (discussed later bellow) are shown, but multiple processors 24 and 28 can be used in a single device and would thus correspond to multiple modules.

When a packet that is part of a particular multimedia data stream is received at port 25, the packet processor 24 analyses an application connection port identifier, preferably, for example, a User Datagram Protocol (“UDP”) port number contained in the packet, to determine to which port and channel the packet should be routed. As known in the art, UDP application port numbers may be used in conjunction with IP addresses for specialized and unique purposes. In the present embodiment it is used to indicate where a packet should be sent.

For content that is requested from within a particular operator's addressable network 12, a query to stream mapping table 26 may return a connection identifier to be assigned to the stream corresponding to the requested content. Network 12, for example, represents what is typically an operator's own intranet network that is isolated from a public network, such as the internet, 20, as shown in FIG. 1. Network 12, along with the operator's servers that are connected to the network without an intervening connection to a public network, may be referred to in the art collectively as a ‘walled-garden’ network. Thus, the connection identifier typically is not already contained in a packet that is output from a server from within the walled-garden, in contrast to the typical packet received by network 12 from internet 20, as shown in FIG. 1.

In assigning a connection identifier from stream mapping table 26, available port, channel and program combination assignments are selected in a top down fashion. The first available (currently unassigned) channel, port and program number combination are assigned to the first packet of a stream and all other packets of the same stream as long as the communication session is active. When a session ends, the port, channel and program number combination are returned to the pool of available connection identifiers in stream mapping table 26. In general, the terms ‘first available’ describe the connection identifier having the lowest values for port, channel and program number, in that order, from table 26 when the query to the table is made to retrieve an identifier to assign to a packet. The “first available” distribution can be overridden by specific mapping declarations, if desired, and the stream mapping table 26 can support such.

If an incoming packet received at port 25 has an address with a data prefix (e.g., 10.x.x.x, for example), the packet is routed through processor 24 to DOCSIS processor 28 for DOCSIS processing known in the art, such as for example, coordinating upstream and downstream packet streams. Processor 24 assigns the next available port, channel and program according to the next available combination from table 26.

Stream mapping table 26 may be stored in a storage device, RAM memory, hard drive, flash memory, etc., that along with processors 24 and 28, and switches 30 and 32, may be collectively referred to herein as combination transmission device 34. Streams are routed by routing and/switching devices known in the art and are symbolically represented by port switch 30 and channel switches 32. Thus, switch 30 may switch an incoming stream of packets between a plurality of port switches 32A-n, each of which can further switch the stream between a plurality of port QAM channels 36A-n, which correspond to separate frequencies that transmit signals each one of a plurality of ports 38. It will be appreciated that QAM channels 36A-n represent the possible channel frequencies that can be used to transmit signals from a QAM transmitter 37. Furthermore, a QAM transmitter 37 may use the same frequencies 36 as another QAM transmitter, since the output of each transmitter is provided over separate ports 38. However, each output QAM channel frequency 36A-n from a given QAM transmitter 37 will be different from other QAM channel frequencies being output from the same QAM port 38.

When a connection identifier has been assigned to a packet stream, switches 30 and 32 are operated according to the connection identifier so that the packet stream is output from the port 38 and over the channel frequency 36 corresponding to the connection identifier assigned to the packets. In addition to the assigned port and channel designations in connection identifier, the connection identifier also contains a program number that is unique to the channel. As discussed above, in the preferred embodiment, 127 programs may be transmitted from a given channel depending on bandwidth of each program. It will be appreciated that for a 6 MHz channel, a typical 256 QAM channel has a capacity of 38.8 Mbps whereas a 64 QAM channel typically has capacity of 26.94 Mbps. If each program comprises a small amount of information, it is conceivable that 127 programs could be transmitted in the same QAM channel.

However, the type of programming content being transmitted generally is an indicator of the amount of bandwidth the program will consume. If a standard definition digital television programs are being transmitted in a channel 36, then possibly ten programs could be transmitted downstream if each used on average 3.8 Mbps. On the other hand, a high definition television (“HDTV”) program may need almost 20 Mbps, in which case two programs at most could be transmitted in a 256 QAM channel. And, if one or two HDTV programs needed 20 or more Mbps each, then only one HDTV program could be transmitted in a given 256 QAM channel 36. This is an undesirable scenario for an operator because the remaining 20 Mbps would be unused, and thus in a sense, wasted.

To mitigate bandwidth waste, operators desire to route as many programs as possible onto a given QAM channel. Thus, if one channel is carrying an HDTV program, the remaining available bandwidth may be used by multiple standard definition television programs. For example, if an HDTV program uses 20 Mbps, and a standard television program signal needs 4 Mbps, then one HDTV program and four standard definition program signals could be transmitted downstream in a typical 256 QAM channel. This would result in 36 of the available 38.8 Mbps of the channel being used. Thus, only 1.8 Mbps are wasted.

While this scenario uses almost all of the available bandwidth, combined transmission device 34 may be able to allocate the remaining unused bandwidth by allocating and routing data packets of a packet stream to the same output port 38 as the HDTV program signal and the four standard definition TV program signals. Since data packet streams, such as, for example, DOCSIS data streams, typically do not use as much bandwidth, one or more DOCSIS data streams may be combined with the HDTV and standard definition program streams for transmission on the same QAM channel 36 from the same output port 38. Accordingly, an operator can efficiently allocate nearly all of the available bandwidth in a given QAM channel, thereby reducing or eliminating unused bandwidth.

To facilitate the combining of multimedia and data packet program streams in the same QAM channel from the same output port, an available connection identifier from table 26 is retrieved and inserted into the multimedia packets corresponding to a given program. For example, if a requested HDTV channel from the operator's video server is received at addressable port 25, the next available connection identifier is selected and added to all of the packets associated with the HDTV program. Assuming that port 32B channel D (328 MHz) is currently unused, combined transmission device 34 may route the program streams (as known in the art, a program may comprise multiple streams and will be discussed later) associated with the HDTV program to this channel and port, used in combination with program 1, and insert the appropriate program identifiers corresponding to this combination into the program packets. Next, according to table 26, the four standard definition programs would be assigned to port 32B channel D programs 2-5 respectively. To fill out the rest of the available bandwidth of port 32B channel D, a DOCSIS data stream is processed through processor 28 and assigned port 32B channel D program 6.

As each port/channel/program is assigned into the corresponding packets being transmitted from port 32B on channel D, the AVAIL flags in the corresponding fields in table 26 are unmarked to indicate that these connection identifiers are not available when device 24 next queries table 26 to retrieve an assignment for another program. In addition, as programs are assigned, a value corresponding to the bandwidth associated with the programs to which the corresponding identifier is assigned may be entered into the BW field. Thus, processor 24 can determine whether a given program can ‘fit’ into a given port/channel combination based on the total amount of bandwidth already allocated to the programs assigned to that port/channel. If the program cannot ‘fit’ into the channel associated with the next available connection identifier returned in response to the query of table 26, processor 24 returns the connection identifier to table 26—preferably by marking the AVAIL flag to indicate the channel is available for use by another program.

Thus, the basic packet flow of packets received at port 25 through combination transmission device 24 according to available port, channel and program combination from table 26 is described. It will be appreciated that one program may comprise multiple streams, as discussed above. For example, a HDTV program, either from a broadcast television feed or from a movie server, typically comprises a video stream, one or more audio streams to facilitate surround sound, a closed captioning stream, and other information streams known in the art. In the preferred MPEG2 Transport protocol, each stream within a program is typically assigned a program identifier (“PID”) as known in the art. For a given channel, a program may comprise preferably up to 16 different streams, corresponding to 16 different PIDs.

As discussed above, processor 24 directs the switching arrangement of switches 30 and 32A-n according to the connection identifier returned from table 26. In determining whether a given program will ‘fit’ into an assigned channel, bandwidth and policy manager 39 cooperates with the processor in determining the best port and channel combination to assign the program streams. Manager 39, along with game server 18 and VOD server 40 may be located at head end 14, which preferably communicates with port 25 of device 34 via addressable network 12, which typically connects an operator's distributed locations within its ‘walled-garden’ as discussed above.

The equipment at the operators head end and other walled-garden locations typically provide programming content in response to a request from a user. Such a request may be to simply receive broadcast television programming, which would typically be delivered from the operator's broadcast equipment at the head end 14. Other possible programming content types may include, but are not limited to, video on demand (“VoD”) from VoD server 40, or content in a game session delivered from game server 18. The requests for content are typically made using DOCSIS set top gateway (“DSG”) technology. DSG, known in the art, facilitates signaling between a CMTS (the functions of which are symbolized by DOCSIS processor 28) and a cable modem. Typically, a DSG controller 42 connects a CMTS and a cable modem, and may use a channel outside of the normal upstream and downstream data channels for messaging between the two.

In the figure, cable modem circuitry and video set top box circuitry are shown as part of a device, such as a combined set top box 44, familiar to subscribers who receive digital cable services from a cable company. Set top box 44 can request a VoD program from VoD server 40. The STB 44 makes the request via DSG controller 42, which forwards the request as a message to server 40. It will be appreciated that DSG controller may be located at the head end near server 40, or somewhere else with the walled garden of the operator-controlled network 12, including within VoD server 40. DSG messaging between a user's STB 44, the DSG controller 42 and the server located at the head end 14, for example, is known in the art and thus a detailed discussion of DSG messaging need not be undertaken.

The DSG message from the STB 44 to the VoD server 40, contains a unique identifier corresponding to the user's STB 44, such as, for example, a media access control (“MAC”) address, as known in the art. The DSG controller can query device mapping table 46, which maps each unique MAC address to the output port 38 to which it is connected. In the figure, user STB 44 is shown to have a MAC address of MAC2 (it will be appreciated that MAC addresses are typically binary or hexadecimal values, but is labeled MAC1, MAC2, MACn, for simplicity). Table 46 maps MAC2 to output port 38B, and possibly a channel if the user device to receive packets is a cable modem. Thus, DSG controller can send a message, via DSG messaging, containing output port information to which the requesting STB is physically connected. Tables 46 and 26 are synchronized such that when processor 24 queries table 26 to determine the next available connection identifier and bandwidth availability, the query filter will request only the connection identifiers that satisfy the filter criteria—which in the scenario here discussed correspond to the B output port 38B.

When an incoming DOCSIS data packet is received at port 25, the MAC address of the destination cable modem 48 is found in table 46 and the associated channel and port number are returned. Policy manager 39 uses this port value to filter records from table 26, and the next available connection identifier from the filter is returned. It will be appreciated that policy manager 39 can be external or internal to device 34, although FIG. 2 shows the policy manager as being located and connected externally with respect to device 34. When the connection identifier has been assigned to packets of the DOCSIS stream by processor 24, the packets are processed by DOCSIS processor 28 so that upstream traffic associated with the downstream DOCSIS packet stream can be maintained for the communication session that corresponds to the assigned connection identifier.

It will be appreciated that all DOCSIS streams, regardless of the device address to which they are directed, contain the PID value 1FFE. This contrasts with the PIDs of multimedia content, for example, which typically have multiple PIDs within a given program. Each connection identifier, corresponding to a given program, can accommodate 16 streams. However, each non-DOCSIS multimedia stream within a program is identified by a PID that is different and unique from other PIDS within the program. Furthermore, PIDs are assigned from PID table 50, which maintains a pool of 8192 PIDS known in the art, except that PIDS reserved for MPEG and DVB are excluded from available PIDs in the PID table. After DSG session control messaging, confirming and initiating of a multimedia session, processor 24 queries PID table 50 and inserts the next available PID into the packet, as discussed above.

DSG messaging also informs the requesting device, STB 44 or cable modem 48, for example, the connection identifier that corresponds to the requested stream. Accordingly, the receiving device can tune its tuner to receive packets on the channel frequency specified in the connection identifier. In addition, DSG messaging informs the receiving device the program number to expect and the respective PIDs that identify the streams that are included in the program. Thus, DSG messaging, facilitated by DSG controller 42, virtually connects user devices 44 and 48, combined transmission device 34 and servers located at head end 14 over walled-garden network 12.

These virtual connections, indicated on the figure by dashed lines, allow communication between the components and querying of table 26, 46 and 50. The results from these queries can be forwarded to the other components using DSG. This use of DSG messaging provides the advantage that the time elapsed between a user requesting content and the content being available at the user's device is minimized. In addition, bandwidth manager 39 and processors 24 and 28 can cooperate to maximize usage of available bandwidth on a given QAM channel, by selectively and actively directing programs, either multimedia, DOCSIS data, or a combination of both, over a single QAM channel such that as much available bandwidth as possible is allocated to the multiple programs carried by the channel.

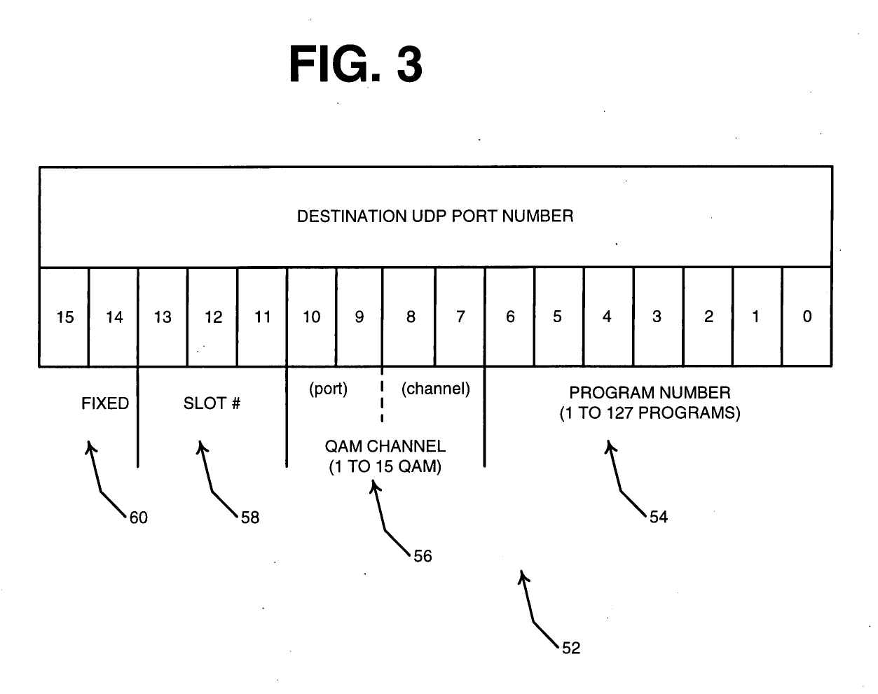

Turning now to FIG. 3, an embodiment of the bit arrangement of a UDP port connection identifier 52 is shown. Identifier 52 is preferably a sixteen-bit value, where bits 0-6 contain a program number value 54, bits 7-10 contain a QAM channel value 56 corresponding to one of a plurality of QAM channel frequencies and bits 11-13 contain a slot number value 58 corresponding to the modular slot in a device that can accept a plurality of connection modules. Bits 14-15 contain reserved number values 60, and are preferably both set to 1 to comply with IANA reserved numbers, as known in the art.

As discussed above, a device may contain one or more modules that facilitate combining downstream traffic streams of different types over a single QAM channel frequency. Slot value 58 of a connection identifier in a packet instructs processor 24, shown in FIG. 2, which module in the combined transmission device to forward the packet. QAM channel 56 can direct the transmission device which output port and which QAM channel on that port to transmit a packet stream. Finally, program value 54 instructs which program number to assign to a program stream. Processor 24 inserts this program number (along with the rest of the connection identifier) into packets related to a program, and will send, via DSG messaging, as discussed above in connection with the discussion of FIG. 2, to the receiving cable modem or digital STB.

In an embodiment, the seven bits of the program number value 54 can indicate 127 different program numbers. QAM channel value 56 can indicate sixteen different QAM channel frequencies, and slot number value 58 can indicate eight different modules in a combined transmission device. In such an embodiment, each of the up to eight modules could have a single physical output port RF connection with sixteen different QAM channel frequencies available from each port. Within each separate QAM channel, 127 different programs could be supported, with each program capable of carrying typically up to sixteen different streams having unique PIDS.

In a preferred embodiment, using modules having two quad-bonded RF output ports, each port can transmit signals at one of four different QAM channel frequencies. In such embodiment, bits 7 and 8 can be used to indicate one of four QAM channel frequencies and bits 9 and 10 can be used to indicate one or the other of the two RF output ports. Alternatively, bits 7-9 can be used to indicate one of up to eight QAM channel frequencies and bit 10 can indicate one of the two ports on an oct-bonded module having two output ports.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

1. A combined transmission device for transmitting one or more requested downstream audio, video and data program packet streams over one of a plurality of communication channels from one of a plurality of output ports to one or more of a plurality of requesting user devices, comprising:
means for receiving data and multimedia packets according to an address;
means for assigning a unique connection identifier to packets composing streams of a requested program according to the physical connection of a requesting user device and the communication channel over which the requested program streams will be transmitted; and
means for processing packets received at the receiving means and for transmitting said packets from an output port over the communication channel frequency that correspond to the output port and communication channel frequency indicated by the connection identifier assigned to the packets by the assigning means.

2. The transmission device of claim 1 further comprising a means for processing data packets capable of coordinating downstream transmission of data packet corresponding to a session with upstream data packets associated with the downstream packets of the session.

3. The device of claim 2 wherein the means for processing data packets includes DOCSIS processing circuitry.

4. The transmission device of claim 1 wherein the means for receiving data and multimedia packets according to an address is a communication port associated with an address.

5. The device of claim 4 wherein the address is an IP address.

6. The device of claim 1 wherein DOCSIS set top gateway messaging packets are used to request a program by a user device and are used to communicate to the assigning means the unique identifier.

8. The device of claim 1 wherein the means for processing and transmitting packets includes a processor capable of querying a stream mapping database table having fields corresponding to output port, communication channel and program number, wherein each combination of port, channel and program number is associated with fields containing flags indicating whether a particular combination is available to be assigned to packets associated with a program and the bandwidth used by the program to which the combination is assigned.

9. The device of claim 8 wherein the means for processing and transmitting packets is coupled to switching/routing means for controlling which port the packets of a particular stream will be transmitted, and wherein the means for processing and transmitting packets is capable of controlling the channel frequency over which the packets will be transmitted.

10. A system for transmitting one or more requested downstream audio, video and data program packet streams over one of a plurality of communication channels from one of a plurality of output ports to one or more of a plurality of requesting user devices, comprising:
a combined transmission device;
means for determining a communication channel from among the plurality of channels over which the one or more requested programs can be transmitted based on bandwidth requirements of the requested programs and available bandwidth of each of the plurality of channels;
wherein the combined transmission device and communication channel determining means are coupled to an addressable network and the user devices are coupled to the combined transmission device; and
wherein a messaging protocol is used to initiate a request for a program from a user device to the communication channel determination means and to send a unique connection identifier from the communication channel determination means to the combined transmission device.

11. The system of claim 10 wherein the combined transmission device includes:
means for receiving data and multimedia packets according to an address;
means for assigning the unique connection identifier to packets composing streams of a requested program according to the physical connection of a requesting user device and the communication channel over which the requested program streams will be transmitted; and
means for processing and transmitting packets received at the receiving means from an output port over the communication channel frequency that correspond to the output port and communication channel frequency indicated by the connection identifier assigned to the packets by the assigning means.

12. The system of claim 11 wherein the addressable network is an Ethernet network.

13. The system of claim 11 wherein the means for receiving data and multimedia packets includes an addressable communication port.

14. The system of claim 11 wherein the channel communication determining device is capable of querying a stream mapping database table having fields corresponding to output port, communication channel and program number, wherein each combination of port, channel and program number is associated with fields containing flags indicating whether a particular combination is available to be assigned to packets associated with a program and the bandwidth used by the program to which the combination is assigned.

15. The system of claim 10 wherein the messaging protocol is DSG.

16. A method for providing audio, video and data traffic signal packets at an output port, comprising
receiving a request for a multimedia or data program from a user device;
step for determining one of a plurality of communication channels over which to send the program to the requesting user device based on which one of a plurality of downstream output ports the requesting device is connected and based on a comparison of the bandwidth required by the program and the bandwidth available in each of the plurality of communication channels;
step for determining a unique program identifier based on the determined one of the plurality of communication channels over which to send the program;
step for assigning the unique identifier to program packets associated with the requested program;
step for routing packets having the assigned program stream to a combined transmission device; and
step for outputting packets received at the combined transmission device from the output port and over the communication channel corresponding to the assigned unique identifier.
